(19) United States
(12) Patent Application Publication
(10) Pub. No.: US 2007/0104028 A1
(43) Pub. Date: May 10, 2007

(54) CONSTRUCTION AND REMOVAL OF SCATTERED GROUND ROLL USING INTERFEROMETRIC METHODS

(76) Inventors: Dirk-Jan Van Manen, Oslo (NL); Johan Olof Anders Robertsson, Oslo (NO); Andrew Curtis, Edinburgh (GB)

Correspondence Address: JEFFREY E. GRIFFIN;WesternGeco, L.L.C., 10001 Richmond Avenue, Houston, TX, 77042, US

(21) Appl. No.: 11/458,868

(22) Filed: Sep. 27, 2006

Related U.S. Application Data
(60) Provisional application No. 60/733,402, filed on Nov. 4, 2005.

(51) Int. Cl. G01V 1/00

(52) U.S. Cl. 367/38

(57) ABSTRACT

A data set can be corrected for the effects of interface waves by interferometrically measuring an interface wavefield between each of a plurality of planned locations within a survey area; and correcting survey data acquired in the survey area for the interface waves. The interface wavefield may be interferometrically measured by receiving a wavefield including interface waves propagating within a survey area, the survey area including a plurality of planned survey locations therein; generating interface wave data representative of the received interface wavefield; and constructing a Green's function between each of the planned survey positions from the interface wave data. Other aspects include an apparatus by which the interface wavefield may be interferometrically measured and a computer apparatus programmed to correct the seismic data using the interferometrically measured interface wave data.

The earlier effective filing date of U.S. Provisional Application 60/733,402 filed Nov. 4, 2005, is hereby claimed.

### BACKGROUND OF THE INVENTION

1. Field of the Invention

The present invention pertains to surveying or remotely detecting properties of the interior of a medium and, more particularly, to a technique for eliminating the effects of surface-related waves in recorded data.

2. Description of the Related Art

Seismic exploration is conducted on both land and in water. In both environments, exploration involves surveying subterranean geological formations for hydrocarbon deposits. A survey typically involves deploying acoustic source(s) and acoustic sensors at predetermined locations. The sources impart acoustic waves into the geological formations. Features of the geological formation reflect the acoustic waves to the sensors. The sensors receive the reflected waves, which are detected, conditioned, and processed to generate seismic data. Analysis of the seismic data can then indicate probable locations of the hydrocarbon deposits.

However, not all of the acoustic waves propagate downward into the geological formation. Some of the acoustic waves are “interface waves” that propagate along an interface between two media instead of through a medium. An interface wave can travel at the interface between the Earth and air—e.g., surface waves—or the Earth and a body of water—e.g., Scholte waves—for instance. Surface waves create in the seismic data what is known as “ground roll.” Ground roll is a type of coherent noise generated by a surface wave that can obscure signals reflected from the geological formation and degrade overall quality of the seismic data resulting from the survey. Consequently, most surveys attempt to eliminate, or at least reduce, ground roll.

Techniques for mitigating ground roll include careful selection of source and geophone arrays during the survey and filters and stacking parameters during processing. However, because the ground roll can be heavily (back)scattered by near-surface heterogeneities, conventional frequency and wave number (“FK”) -filtering techniques are often unsuccessful: the noise is distributed over a large range of (out-of-plane) wave numbers outside the expected FK-slice in a manner that is difficult to predict without highly detailed knowledge of the near-surface scatterers.

The phenomenon of interface waves is described above in the context of seismic surveying. However, their existence is not limited to that technology. The phenomenon may also be encountered in electromagnetic surveying or non-destructive testing, for instance. Interface waves raise similar concerns and have similar effects on the efficacy of these technologies as well.

Relatively recently, independently of the surface wave effects discussed above, effort has been directed to time-reversal, interferometry, and mathematical constructs known as Green's functions. A Green's function for a given differential equation is the solution to the inhomogeneous equation with a spatial delta function as the source. Time-reversal of acoustic, elastodynamic or electromagnetic wavefields is possible because of invariance of the wave-equation under time-reversal. It is possible to time-reverse an acoustic wavefield after propagation through a medium by first recording it on a surface surrounding the medium and subsequently re-injecting it, time-reversed, at the receiver locations. See Cassereau, D. & Fink, M., “Trans. Ultrason. Ferroellectr. Freq. Control,” 39 IEEE Transactions 579 (1992); Cassereau, D. & Fink, M., “Focusing with Plane Time-Reversal Mirrors: an Efficient Alternative to Closed Cavities” 94 J. Acoust. Soc. Am. 2373 (1993); Derode, A., Roux, P., & Fink, M., “Robust Acoustic Time Reversal with High-Order Multiple Scattering”, 75 Phys. Rev. Lett. 4206 (1995) (“Derode et al. (1995)”). Thus, by re-creating the time-reversed boundary conditions, the wavefield starts to retrace its path through the inhomogeneous medium before it refocused on the original source locations.

The relationship between wavefield time-reversal and interferometry is explored in Derode, A., et al., “Recovering the Green's Function From Field-Field Correlations in an Open Scattering Medium,” 113 J. Acoust. Soc. Am. 2973-2976 (2003). Interferometry is a means of constructing Green's functions between pairs of points, at each of which is a receiver recording ambient vibrations of the medium. No explicit sources are required at either point. Alternatively, interferometric Green's functions can be constructed between such points if, at each, the responses due to separate controlled sources, illuminating a portion of the medium from points surrounding the boundary of that portion of the medium, are recorded.

In the first case, the effectiveness of interferometric Green's function synthesis depends on the background noise having all wave-vectors present. In the second case, the sources on a closed surface surrounding the medium need not be distributed more densely than the local Nyquist sampling conditions to ensure complete illumination. It was earlier shown that, in order to refocus the wavefield on an original source location in highly scattering media, it is only necessary that the source of the noise includes a fraction of all wave-vectors (or, alternatively, a small number of controlled sources on the surrounding surface), since scattering itself augments the wave-vector spectrum. See Derode, et al. (1995).

Interferometric techniques have successfully been used to construct approximate earthquake-frequency Green's functions between pairs of receivers in California, using long term (1 month) noise records at each receiver. Shapiro, N. M., et al., “High-Resolution Surface Wave Tomography From Ambient Seismic Noise,” 307 Science 1615-1618 (2005). The surface wave component of the reconstructed Green's function dominates, and is similar to actual Green's functions observed when an earthquake source occurred close to one of the receivers. No published studies have yet synthesized clear seismological body waves using these techniques. This may be a consequence of the attenuative nature of the Earth, or of the biased directionality of noise sources in some locations, but to-date no satisfactory justification has been published.

FIG. 1 illustrates the basic setup and notation for problems involving time-reversal and interferometry. A surface S surrounds the inhomogeneous medium V. The outward normal to the surface is denoted by n. For the sake of clarity, a heuristic treatment of the equivalent acoustic problem is given below by ignoring boundary conditions and taking scalar instead of vector quantities. The receivers/sources on the surrounding surface are implicitly assumed to be situated in a homogeneous embedding. This treatment is therefore at most kinematically correct. However, it is straightforward to extend it to the elastodynamic case and include a more thorough treatment of the boundary conditions such that it is also dynamically correct.

In a first step, an impulsive point source at an arbitrary location A generates a wavefield that is recorded on the surrounding surface S after having propagated through the medium V. The directed edges 100 (only one indicated) radiating from the location A denote Green's functions (including all multiple scattering) between point A and points on the surrounding surface S. In the following, such Green's functions are denoted G(x′,A,t). In a second step, the receivers 103 (only one indicated) on the surrounding surface S act as Huygens' sources emitting the recorded wavefield backwards (i.e., time-reversed). The wavefield starts to retrace its original path before focusing at the original source location A. As a result, in point B, the time-reversed Green's function between point A and point B, denoted G(B,A,t) is observed. Thus, in this technique the time-reversed Green's function between points A and B can be directly measured following re-creation of the time-reversed boundary conditions on the surrounding surface.

The time-reversed Green's function between A and B can also be calculated (as opposed to measured) from an application of Kirchhoff-Helmholtz theorem (the mathematical formulation of Huygens' principle). This also requires knowledge of the Green's functions between point B and the surrounding surface, denoted G(B,x′,t). Then, it is not very difficult to show that:

$${G}_{h} ( B , A , t ) = {∮}_{S} ( G ( B , {x}^{′} , t ) * \frac{\partial }{\partial n} G ( {x}^{′} , A , - t ) - \frac{\partial }{\partial n} G ( B , {x}^{′} , t ) * G ( {x}^{′} , A , - t ) ) ⅆ {x}^{′} \qquad ( 1 )$$

Where the operator “*” denotes convolution and Gₕ(B,A,t) denotes the homogeneous Green's function—i.e., the superposition of the forward and time reversed Green's functions Gₕ(B,A,t)=G(B,A,−t)+G(B,A,t). In Eq. (1), the homogeneous Green's function arises because the wavefield converging on the original source location is not absorbed by an inverse source and immediately starts diverging again.

It has been suggested that when there are outgoing boundary conditions on the surrounding surface, the two terms in the integrand are equal but opposite sign. Wapenaar, K. & Fokkema, J., “Seismic Interferometry, Time-Reversal and Reciprocity,” EAGE 67th Annual Meeting, conference abstract (2005). Furthermore, when the Fraunhofer far-field conditions apply (i.e., normal incidence approximation), Eq. (1) reduces to the simple expression:

$${G}_{h} ( B , A , t ) = c \cdot {∮}_{S} G ( B , {x}^{′} , t ) * G ( {x}^{′} , A , - t ) ⅆ {x}^{′} \qquad ( 2 )$$

where c denotes a constant of proportionality. Thus, under suitable circumstances, the (homogeneous) Green's function between points A and B can also be calculated by cross-correlating the Green's functions from point A to the boundary and back to point B.

### SUMMARY OF THE INVENTION

A data set can be corrected for the effects of interface waves by interferometrically measuring an interface wavefield between each of a plurality of planned locations within a survey area; and correcting survey data acquired in the survey area for the interface waves. The surface wavefield may be interferometrically measured by receiving a wavefield including interface waves propagating within a survey area, the survey area including a plurality of planned survey locations therein; generating interface wave data representative of the received interface wavefield; and constructing a Green's function between each of the planned survey positions from the interface wave data. Other aspects include an apparatus by which the surface wavefield may be interferometrically measured and a computer apparatus programmed to correct the seismic data using the interferometrically measured surface wave data.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a conventional setup and notation for time-reversal and interferometric problems;

FIG. 2 depicts a land-based seismic survey practiced in accordance with the present invention;

FIG. 3 shows selected portions of the hardware and software architecture of a computing apparatus such as may be employed in some aspects of the present invention;

FIG. 4 illustrates a computing system on which some aspects of the present invention may be practiced in some embodiments;

FIG. 5 illustrates one particular method by which surface wave data can be interferometrically measured;

FIG. 6 depicts a land cross-spread seismic survey layout for a planned seismic survey and a data acquisition in accordance with the present invention;

FIG. 7 shows the planned locations for the receivers and seismic sources of the survey layout of FIG. 6;

FIG. 8 illustrates interferometric scattered ground roll Green's function construction in accordance with the present invention;

FIG. 9 is a schematic illustration of how strong multiple scattering of ground roll in the near-surface layer augments the wave number spectrum of just two controlled or passive noise sources;

FIG. 10 depicts an embodiment of the present invention wherein the surface wave data is collected using a source/receiver arrangement that is the reciprocal of that shown for the embodiment of FIG. 8; and

FIG. 11 illustrates a method for use in seismic surveying in accordance with another aspect of the present invention by which seismic data can be corrected for ground roll.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The present invention pertains to surveying or remotely detecting properties of the interior of a medium and, more particularly, to a technique for eliminating the effects of surface-related waves in recorded data. The detection may occur from on or above the medium's surface. “At the surface” includes not only physically on the surface, but also in the shallow sub-surface or near-surface. What constitutes “near surface” will depend on the domain of the application. For example, seismic surveying, electromagnetics, non-destructive testing, etc. In seismic surveying, for example, sources and/or receivers may be buried anywhere from a few centimeters to tens of meters depending on the depth of the formations of interest.

This technique can be used for seismic surveys, for electromagnetic surveying, for non-destructive testing, and a variety of other applications. However, so as to further an understanding of the present invention, it will be disclosed in the context of several alternative seismic surveying embodiments. These seismic surveying embodiments are land-based surveys, but the invention is equally applicable to seabed seismic surveys. Indeed, it is to be understood that the present invention is not limited to seismic surveying in general, but also encompasses embodiments applicable in alternative fields, such as electromagnetic surveying, non-destructive testing, etc.

It has recently been shown, using reciprocity, that instead of having sources inside the medium and receivers all around it is often advantageous to put the sources on the surrounding surface and measure in the interior. van Manen, D. et al., “Modeling of wave propagation in inhomogeneous media,” Phys. Rev. Lett. 94, 164301 (2005). In particular, this leads to an efficient full waveform modeling algorithm. When the sources on the surrounding surface are uncontrolled and fired simultaneously, individual Green's functions are no longer available: only their superposition is recorded in points A and B. In such cases, the best that can be hoped for is that the sources are mutually uncorrelated in which case equation (2) further simplifies to:
Gₕ(B,A,t)=G(B,·,t)* G(A,·,−t) (3)
The operator “·” indicates that this Green's function is due to a superposition of random orthogonal noise sources whose location is not necessarily known or controlled as described below.

Note that the same identity—i.e., Eq. (3)—has been derived independently in a number of different settings and based on different arguments. The derivation based on Kirchhoff-Helmholtz or any other form of reciprocity/representation theorem is valid in, at least partially, open media with transient wavefields on the surrounding surface (to avoid infinite listening time). In closed media or in cases where the wavefield can be considered as diffuse, derivations are usually based on a modal expansion of the wavefield. In such cases, the normal modes have to be equipartitioned (all wave numbers have to be excited throughout the medium equally). Furthermore, in these cases, the sources no longer have to be distributed on a surface surrounding the medium but can be (randomly) distributed throughout the medium as well.

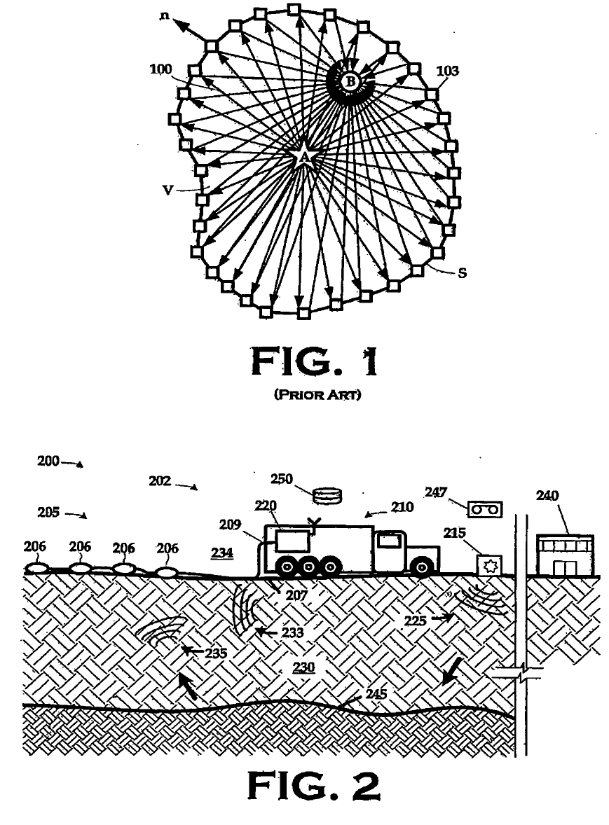

FIG. 2 illustrates an exemplary land-based seismic survey 200 in profile. The seismic survey 200 employs a seismic survey system 202 by which seismic data may be acquired for processing in accordance with one aspect of the present invention. The seismic survey system 202 includes a seismic recording array 205 and may be constructed in accordance with conventional practice. The recording array 205 includes a plurality of seismic receivers 206 positioned about an area to be surveyed on the surface 207. The seismic receivers 206 are implemented, in the illustrated embodiment, with, e.g., geophones as are known to the art.

FIG. 2 also shows a seismic source 215 and a data collection unit 220. The seismic source 215 may be a sweep source or an impulse source as are known in the art. Typically, embodiments will employ multiple seismic sources 215 in arrays using techniques known to the art. The data collection unit 220 is centrally located on the recording truck 210. However, as will be appreciated by those skilled in the art, various portions of the data collection unit 220 may be distributed in whole or in part, e.g., across the seismic recording array 205, in alternative embodiments.

The geological formation 230 is relatively simple, and presents a single seismic reflector 245. As those in the art will appreciate, geological formations can be, and typically are, much more complex. For instance, multiple reflectors presenting multiple dipping events may be present. FIG. 2 omits these additional complexities for the sake of clarity and so as not to obscure the present invention. However, the invention is equally applicable in the presence of such complexities.

The seismic source 215 generates a plurality of seismic survey signals 225 in accordance with conventional practice. The seismic survey signals 225 propagate through the geological formation 230 and are reflected by the reflector 245. The seismic receivers 206 receive the reflected signals 235 from the geological formation 230 in a conventional manner. The seismic receivers 206 then generate data representative of the reflections 235, and the seismic data is embedded in electromagnetic signals. The electromagnetic signals may be electrical or optical, for example. The seismic survey signals 225 and the reflections 235 are comprised of what are known as “body waves,” or waves that propagate into the geological formation 230. Body waves comprise what are more technically known as pressure waves (“P-waves” ) and shear waves (“S-waves”).

In addition to the body waves 225, 235, the seismic source 215 will also generate interface waves, i.e., the surface waves 233 in the illustrated embodiment. Note that, in a seabed survey, the interface waves are Scholte waves. Surface waves propagate, as was mentioned above, at the interface between two media, as opposed to through a medium. The surface waves 233 of the illustrated embodiment are conceptually shown propagating at the interface between the geological formation 230 and the air 234. The surface waves 233 are also received by the seismic receivers 206 along with the body waves 225, 235. Thus, the data generated by the seismic receivers 206 will also include surface wave data along with the seismic data, which is undesirable. Note that, as will be discussed further below, there may be many sources for surface waves aside from controlled sources like the seismic source 215.

The signals generated by the seismic receivers 206 are communicated to the data collection unit 220. Data collected by the seismic receivers 206 is transmitted over the communications link 209 to a data collection unit 220 in the illustrated embodiment. Note that, in some alternative embodiments, the recording array 205 may transmit data collected by the seismic receivers 206 over a wireless connection.

The data collection unit 220 collects the seismic data for processing. The data collection unit 220 may process the seismic data itself, store the seismic data for processing at a later time, transmit the seismic data to a remote location for processing, or some combination of these things. Typically, processing occurs in camp or at some later time rather than in the recording truck 210 because of a desire to maintain production. The data may therefore be stored on a magnetic storage medium, such as a tape 247 or disk array 250, in the recording truck 210 by the data collection unit 220. The magnetic storage medium is then transported to a processing center 240 for processing in accordance with the present invention. Alternatively, the data may be transmitted wirelessly to the processing center 240, e.g., over a satellite link (not shown) and stored there. Some alternative embodiments may employ multiple data collection systems 220.

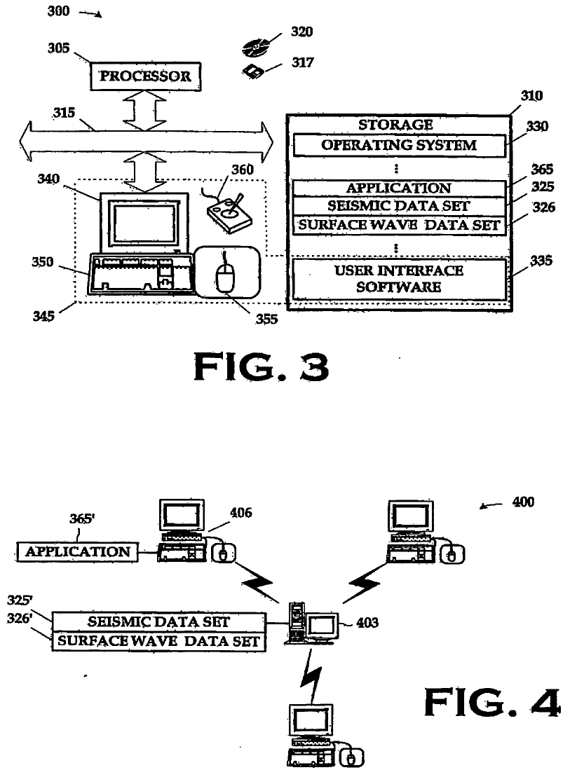

In one aspect, the present invention is a software implemented method for correcting a seismic data set using an interferometrically measured surface wave data set. FIG. 3 shows selected portions of the hardware and software architecture of a computing apparatus 300 such as may be employed in some aspects of the present invention. The computing apparatus 300 includes a processor 305 communicating with storage 310 over a bus system 315. The storage 310 may include a hard disk and/or random access memory (“RAM”) and/or removable storage such as a floppy magnetic disk 317 and an optical disk 320.

The storage 310 is encoded with a seismic data set 325. The seismic data set 325 is acquired as discussed above relative to FIG. 2. The data in the seismic data set 325 is representative not only of the body waves 225, 235, but also the surface waves 233. That is, the seismic data set is “contaminated” with surface wave data. In accordance with this particular aspect of the invention, the storage 310 is also encoded with an interferometrically measured surface wave data set 326 acquired as discussed further below.

The storage 310 is also encoded with an operating system 330, user interface software 335, and an application 365. The user interface software 335, in conjunction with a display 340, implements a user interface 345. The user interface 345 may include peripheral I/O devices such as a keypad or keyboard 350, a mouse 355, or a joystick 360. The processor 305 runs under the control of the operating system 330, which may be practically any operating system known to the art. The application 365 may be invoked by the operating system 330 upon power up, reset, or both, depending on the implementation of the operating system 330. The application 365, when invoked, performs the method of the present invention. A user may alternatively invoke the application in conventional fashion through the user interface 345.

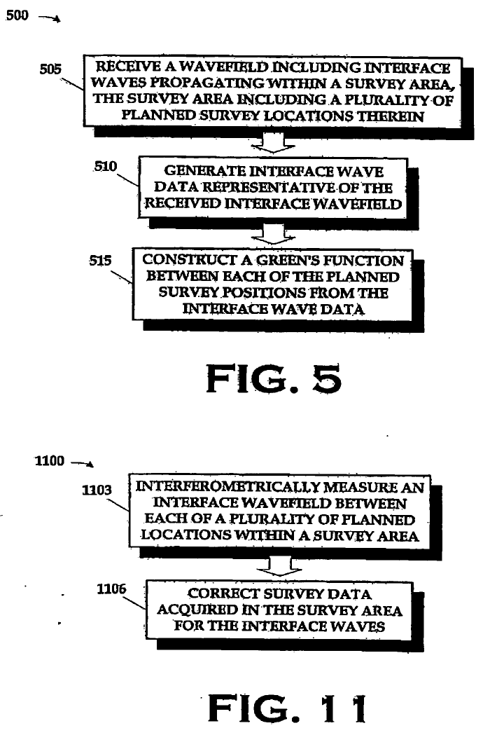

Note that there is no need for the seismic data set 325 to reside on the same computing apparatus 300 as the application 365 by which it is processed. Some embodiments of the present invention may therefore be implemented on a computing system, e.g., the computing system 400 in FIG. 4, comprising more than one computing apparatus. For example, the seismic data set 325 may reside in a data structure residing on a server 403 and the application 365′ by which it is processed on a workstation 406 where the computing system 400 employs a networked client/server architecture. Furthermore, although the surface wave data set 326 is also shown residing on the server 403, there is no requirement that the seismic data set 325 and the surface wave data set 326 reside together.

The computing system 400 illustrated in FIG. 4 is a network employing a client/server architecture. However, there is no requirement that the computing system 400 be networked. Alternative embodiments may employ, for instance, a peer-to-peer architecture or some hybrid of a peer-to-peer and client/server architecture. The size and geographic scope of the computing system 400 is not material to the practice of the invention. The size and scope may range anywhere from just a few machines of a Local Area Network (“LAN”) located in the same room to many hundreds or thousands of machines globally distributed in an enterprise computing system.

Thus, some portions of the detailed descriptions herein are consequently presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

As was mentioned above, the surface wave data set 326 is interferometrically measured. This may involve additional data acquisition, although not necessarily in all embodiments. FIG. 5 illustrates one particular method 500 by which surface wave data can be interferometrically measured. The method 500 begins by receiving (at 505) a surface wavefield propagating within a survey area including a plurality of planned survey locations therein. Next, surface wave data representative of the received surface wavefield is generated (at 510). The method 500 then constructs (at 515) a Green's function between each of the planned survey positions from the surface wave data.

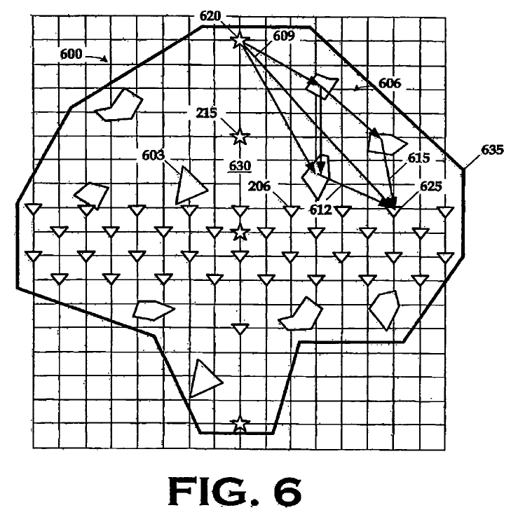

More particularly, the planned, land-based, cross-spread seismic survey layout 600, shown in FIG. 6, for a survey such as the survey 200, shown in FIG. 2. Note that this is a “bird's eye” view rather than a profile. The seismic survey layout 600 comprises, in this particular embodiment, a plurality of seismic sources 215 (only one indicated) and seismic receivers 206 (only one indicated). A plurality of near-surface inhomogeneities 603 (only one indicated) are also shown.

The near-surface inhomogeneities 603 scatter ground roll, as is shown for a part of the survey layout 600. The directed edges, generally designated 606, denote direct wave paths (i.e., a scattering order 0) 609; singly scattered surface wave paths (i.e., a scattering order 1) 612; and doubly scattered surface wave paths (i.e., a scattering order 2) 615, between a particular source 620 and a particular receiver 625 in the survey layout 600. More accurately, the directed edges 609, 612, 615 show the final legs of their respective paths. Additional orders of scattering typically also occur in such a scenario.

The survey layout 600 is located in a survey area 630 defined by a perimeter 635. The survey area 630 may encompass the entire survey layout 600 or only a portion thereof. The perimeter 635 may be regularly shaped or irregularly shaped. In the embodiment of FIG. 6, the survey area 630 encompasses the entire survey layout 600 and the perimeter 635 is irregular in shape. The perimeter 635 may also be tangible or intangible. For instance, the perimeter may be defined by a physical barrier, such as a road, or a wired array of sources (as disclosed more fully below) surrounding the survey layout 600. Alternatively, the perimeter 635 may be an intangible, “imaginary” line determined by physical coordinates on a map, for example. Furthermore, although the perimeter 535 is shown as a line of discernible dimension along the ground surface, this is for ease of illustration and is not necessarily the case in all embodiments. In some embodiments, for example, the perimeter 635 may be on the order of several meters wide.

Still further, the perimeter 635 is shown as one-dimensional—i.e., enclosing a two-dimensional surface. The invention is not limited to such, as is implied by the use of the term “surface” above for the perimeter 635. The one-dimensional perimeter is a limting case of a two-dimensional surface enclosing a three-dimensional survey area. Thus, the 3D survey area (length×width×depth) is bounded by the free surface on top, and, e.g., a hemisphere with a radius on the order of several kilometers. The described perimeter 635 is, e.g., the rim of such a hemisphere. In some cases the surface wave construction could include illuminating the model from a larger part of this enclosing surface rather than just the rim intersecting the free surface.

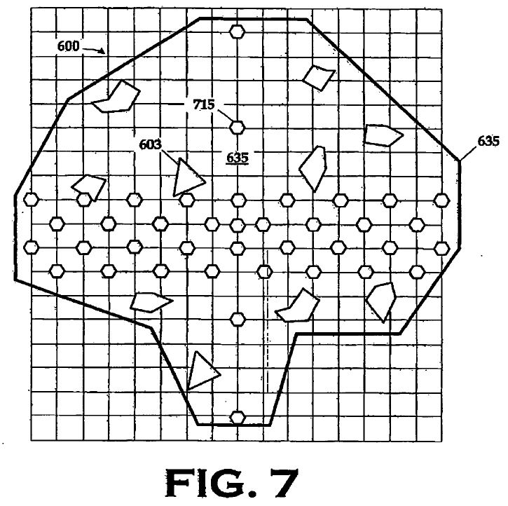

As those skilled in the art will appreciate, the seismic receivers 206 and seismic sources 215 are positioned in locations that are identified with some degree of forethought. Thus, the locations in which they are positioned may be, and are hereafter, referred to as “planned locations.” Note, however, that the present invention is not limited to use with “planned locations”, and that some embodiments may be employed with locations that are randomly selected, or “unplanned.” FIG. 7 illustrates the planned locations 700 (only one indicated) for each of the seismic receivers 206 and seismic sources 215 in the survey layout 600 of FIG. 6. Note that the planned locations 700 are indicated in FIG. 7 alike for both the seismic receivers 206 and the seismic sources 215.

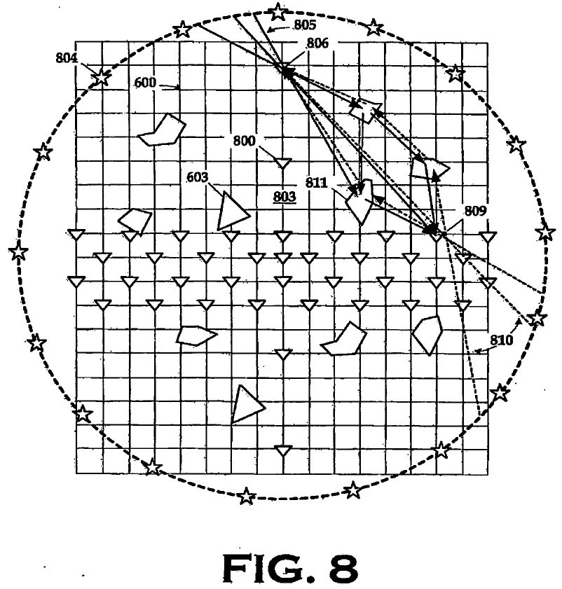

FIG. 8 illustrates the acquisition of surface wave data in accordance with one particular embodiment of the present invention. Receivers 800 (only one indicated) are placed at each of the planned locations 700, shown in FIG. 7, regardless of whether the planned location 700 is intended for a seismic receiver 206 or a seismic source 215, shown in FIG. 6. The receivers 800 may be the same seismic receivers 206 that will be used in the seismic data acquisition illustrated in FIG. 2, or may be different seismic receivers, or may be special purpose receivers.

In this embodiment, the survey area 803 is illuminated from the outside by controlled surface wave sources 804 (only one indicated). Thus, the controlled sources 804 are located on or outside the perimeter 806 and outside the survey area 630. The invention admits wide variation in the implementation of the surface wave sources 804. The surface wave sources 804 may be implemented using standard seismic sources, since their operation generates surface waves. However, as will be discussed further below, there may be many surface wave sources in a given survey area and any suitable source wave source may be used.

The surface wavefield is recorded at each planned location 700—i.e., in both planned source locations and planned receiver locations. The solid, directed edges, generally designated 805, emanating from the surrounding surface—i.e., the perimeter 806 in the illustrated embodiment—show selected wave paths for which the energy passes a particular planned source location 806 before being recorded on the planned receiver location 809. These are paths of stationary phase. More specifically, the difference in traveltime from the point on the surrounding surface—i.e., a controlled surface wave source 804 on the perimeter 806 in the illustrated embodiment—to the planned source location 807 and from the surrounding surface to the planned receiver location 809 is stationary for small shifts in the location of the intersection point of the directed edge 805 and the surrounding surface, along the surrounding surface.

In other words, of all the possible pairs of paths for a particular point, say 811, on the surrounding surface, one to the planned source location, 806, the other to the planned receiver location, 809, the difference in traveltime along those paths is stationary with respect to small perturbations of the point 811 along the surrounding surface, if and only if the one of the paths passes the other planned location and the remainder of this path overlaps/coincides with the other path. Note that, when one realizes that the cross-correlations in the method Eq. (1)-Eq. (3) yield traveltime differences, then summing or integrating over the surrounding surface leaves only those contributions from traveltime differences that are stationary. Thus, the non-overlapping part of the paths (for those pairs with stationary difference), i.e., the part between a planned source and receiver location, is recovered by cross-correlation and summation in accordance with Eq. (1), Eq. (2) and, implicitly, Eq. (3).

The broken, directed edges, generally designated 810, denote wave paths of stationary phase where the energy first passes the planned receiver location 809. Since surface wave data is recorded at each of the planned locations 700, surface wave Green's functions can be constructed between all planned source and receiver locations 700. In the present context, a surface wave Green's function is the surface wave components of the Green's function, i.e., excluding the body wave parts. Some embodiments may also include summation, as is disclosed further below.

Thus, the present invention presents a different way of actually indirectly “measuring” the surface wave Green's functions and, when all the assumptions described above are met, he result is identical to the true surface wave Green's function up to a (constant) scale factor.”. A constant scaling factor can be applied to the interferometrically constructed signal in order to match the amplitude of the real surface wave. The scaling factor is fitted to match either the maximum amplitude or average amplitude of the two signals, but any other method of finding that scaling factor may be used.

The method is therefore deterministic. The present invention will frequently include acquiring additional data over and above that used in conventional techniques. However, it does not use extra sources in every planned source or receiver location, as is true of conventional techniques. For example, using surface wave sources on a perimeter enclosing the survey area and receivers in planned source and receiver locations, the surface wave Green's function between any two recording points can be constructed. Thus, interferometric principles may make it economically feasible to acquire such additional data.

Not all embodiments of interferometric measurement require active illumination by controlled surface wave sources. As was stated above, the surface waves generating the ground roll may result from operation of the seismic sources 215. However, this may not be the only source of surface waves in the survey area 630. FIG. 9 illustrates another particular embodiment in which background noise sources provide a diffuse, directionally unbiased or equipartitioned field.

In a lot of cases, background noise sources pre-dominantly excite surface waves. As those in the art having the benefit of this disclosure will appreciate, there are usually many sources of noise in environments where seismic surveys are taken. Machinery associated with the operation of drilling rigs, for instance, produce vibration. Many fields have flares to burn off excess product and/or control pressures. Pipelines frequently cross survey areas, and the fluid flow through the pipeline causes what is known as “flow noise”. Each of these is a source of coherent noise that may provide a diffuse or equipartitioned field. Note, however, that there may also be many sources of incoherent noise, such as vehicular traffic on a road or off-road vehicular traffic by, e.g., a seismic crew. Even low-flying aircraft may act as sources of noise. These types of noise sources, both coherent and incoherent, may be used to provide a diffuse illumination in accordance with the invention in some embodiments.

Thus, in the embodiment of FIG. 9, background noise sources 900 illuminate the survey area 903 from outside or within the survey area. This particular embodiment may be employed where:
(i) the near-surface of the survey area is sufficiently heterogeneous that the scattered ground roll can be considered diffuse, or
(ii) the noise sources are distributed sufficiently randomly such that the excited wave number spectrum is full and unbiased in its directionality, or
(iii) both the above conditions,
   are met. Then, by placing receivers at planned locations 700, shown in FIG. 7, and continuously, passively recording for, e.g., several hours, it will be possible, in accordance with Eq. (3), to construct interferometric surface wave Green's functions between any two positions for which passive recordings are available. Note that this includes both surface wave Green's functions between all planned source and receiver positions, as well as Green's functions between planned receiver positions.

Note that most of the exemplary noise sources set forth above are coherent noise sources that may be considered “in place.” That is, those noise sources are pre-positioned for reasons unrelated to the implementation of the present invention. The noise they generate may be considered ambient noise. The example of vehicular traffic, however, establishes that noise and noise sources may be introduced for the purposes of implementing the present invention. For instance, one might introduce noise by driving one or more vehicles, such as a truck, at desired locations. Thus, the noise sources may be in-place or introduced and the noise may be ambient or introduced, coherent or incoherent. In this context it may also be advantageous to use specially designed sources that predominantly generate surface waves.

FIG. 9 is a schematic illustration of how strong multiple scattering of surface waves in the near-surface layer augments the wave number spectrum of just two controlled or passive noise sources 900 in a portion 905 of a survey layout such as the survey layout 600 of FIG. 6. The resulting illumination of the planned source and receiver locations 700 approximates that which would result from the embodiment of FIG. 8. The stationary phase paths are also excited. Note how just two noise sources provide a more diffuse illumination which contains all the necessary wave numbers to reconstruct the direct, singly and doubly scattered surface waves between the planned source and receiver locations. Cross-correlation of the diffuse background noise fields would yield the required Green's function. At the same time, these two sources also provide similarly diffuse illumination for other planned source and receiver locations (not shown).

However, in some circumstance, there may not be enough background noise, or the background noise exhibits a bias in its directionality, even though the near-surface is still sufficiently heterogeneous such that scattered surface waves can be considered diffuse. In these circumstances, the background noise may be used as a source to yield approximate results. The results will be degraded from what is typically desired, however, which is why the results are “approximate.” In some circumstances, the approximation represented by the degraded results may nevertheless be sufficient.

Alternatively, receivers may be placed at both planned source and planned receiver positions. A limited number of controlled surface wave sources, distributed randomly throughout or surrounding the medium, can be set off and the resulting surface wavefields recorded. Interferometric surface wave Green's functions can still be constructed between any pair of recording points. In this case the controlled surface wave sources could be set-off either separately or simultaneously by encoding their output using orthogonal sequences. Exemplary encoding may include, for example, using pseudo-random vibrator sweeps. Setting the controlled surface wave sources separately will avoid cross-correlation noise due to imperfect orthogonality of the encoding sequences, but will yield a slower, and thus more expensive, solution to interferometrically construct surface waves.

Returning to FIG. 8, in cases where there is not enough scattering of the surface wavefield to result in a diffuse or equipartioned field from a limited number of controlled or background noise sources, it may still be possible to use interferometric methods to construct all surface wave Green's functions relatively efficiently (e.g., more efficiently than direct measurement). This can be done by illuminating the survey area from the “outside”, e.g., by using controlled surface wave sources distributed on a line surrounding/enclosing the survey area, as is discussed above. In such a case, the controlled sources are spaced sufficiently densely to sample the surface wave fields in the equivalent reciprocal experiment accurately. Note that, because the surface waves are propagating between the planned locations and points on a perimeter enclosing the surface area, there is no requirement that the generated surface wave be diffuse and directionally unbiased.

Again, the controlled surface wave sources could be set-off either separately or simultaneously by encoding their output using orthogonal sequences. Note that, in this case, the theory for interferometric Green's function construction does not rely on arguments of diffusivity or equipartioning of the wavefield. Instead, it relies on an application Kirchhoff-Helmholtz theorem (or more general representation theorems) and reciprocity. In this case, the Green's function between two points is still constructed by cross-correlation of surface wave Green's functions from each source on the enclosing perimeter to those points, followed by a summation (integration) of these cross-correlations for all sources on the enclosing perimeter.

In cases where the controlled sources are encoded using orthogonal sequences, the interferometric Green's function follows simply from cross-correlation of the superposition of encoded surface wave data recorded at the two points. The solid and broken directed edges denote a few paths that propagate from a surrounding source to a planned source (receiver) location via the other planned receiver(source) location. Such paths are stationary with respect to variations in the boundary source location. Cross-correlation and summation (integration) according to Eq. (1) or Eq. (2) again results in the surface wave Green's function.

In principle, the only requirement for the surface wave sources to be able to perform interferometry is that they form a complete time-reversal device for the reciprocal experiment. This means that time-reversed re-emission of the recorded scattered surface waves in the locations of those surface wave sources leads to the surface waves retracing their paths in the medium and undoing the scattering before focusing on the original source locations. This is most easily and demonstrably achieved by fully illuminating (part of) the survey area from a closed perimeter with surface wave sources spaced on the perimeter according to the local Nyquist wavenumber. The embodiment of FIG. 8 is one implementation of this approach. Effectively, this directly implements the Kirchhoff-Helmoltz integral represented in Eq. 1 and Eq. 2. In this case, the surface wavefield does not need to be diffuse or unbiased in its directionality and there are no requirements on the degree of inhomogeneity of the medium.

Such a distribution of sources on a closed perimeter may be obtainable from the main survey. For instance, the survey area 630 in FIG. 6 may be a portion of a much larger survey area not otherwise shown. The perimeter 635 may then be defined by seismic sources (not shown) outside the survey area 630 that are a part of the larger survey layout. This approach, if available, would mean that no additional information needs to be collected before or after the main survey and this is a most efficient and, hence, most cost-effective approach.

In addition, in a lot of cases, the medium is sufficiently heterogeneous to warrant strong scattering of the surface waves and a small number of active sources/passive receivers within (part of) the survey area are enough to eventually capture enough information for accurate time-reversal. In such a case, the strong scattering makes that all waves will eventually pass through one of such active source/passive receiver locations as part of the coda (i.e., the trail of multiply scattered waves that follows the direct wave and slowly dies down) and the long recording time makes up for the lack of information in the spatial dimension. If this is the case, it should again be possible to use a limited number of (randomly distributed) sources from the main survey and to avoid making the extra source effort. These sources might even be located within the survey area itself, as opposed to outside it.

Note that the same conditions apply for the spatio-temporal distribution of the chosen sources from the main survey as for the additional surface wave sources or background noise sources in the other alternatives mentioned above. Also note that it should be possible to reduce any a priori bias in directionality of the surface waves, or at least their sources, by inversely weighting by source density and azimuth.

Note also that this aspect of the invention may or may not include actually generating the surface wavefield. In the embodiment of FIG. 9, the in-place noise sources generated an ambient noise that is sufficiently scattered to propagate a diffuse, directionally unbiased surface wavefield through the survey area. There is therefore no need to actually generate the surface wavefield in this embodiment. However, in some embodiments, the ambient noise may not be of a sufficient level, or sufficiently scattered. In such embodiments, additional surface waves are generated either by introducing additional noise sources or by introducing controlled surface wave sources. In the embodiment of FIG. 8, the characteristics of the surface wavefield are not of concern given the introduction of the controlled surface wave sources and their sufficient density.

There are also several alternative embodiments for constructing surface wave Green's functions interferometrically that can be found by applying reciprocity to the four alternatives discussed above. For example, instead of using controlled surface wave sources on the perimeter and recording the wavefield in planned source and receiver locations it is possible to record the surface waves on the perimeter during the main survey and also sweeping on planned receiver locations and recording on the surrounding perimeter. Surface wave Green's functions can then be constructed in exactly the same way as in the embodiment of FIG. 8. Note that this is a very costly alternative since it involves sweeping at all planned receiver locations in addition to the sweeping at the planned source locations.

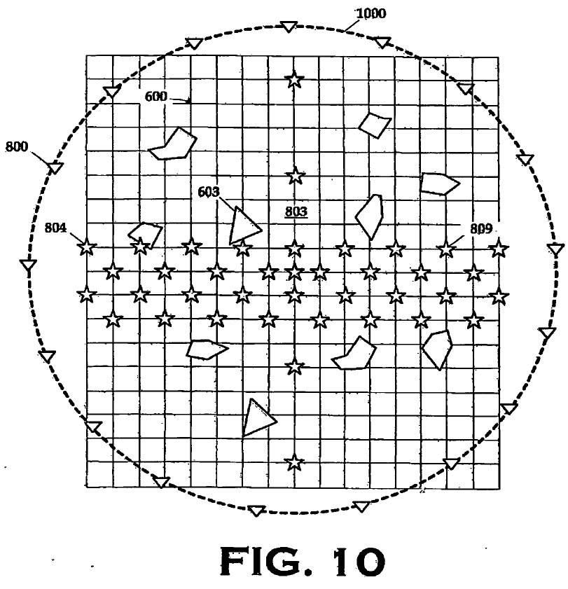

Consider the embodiment of FIG. 10. In this particular embodiment, the controlled surface wave sources 804 (only one indicated) and receivers 800 are positioned in the reciprocal arrangement of the embodiment in FIG. 8. That is, controlled surface wave sources 804 are positioned at the planned positions 715 in the survey area while the receivers are placed on the perimeter 1000. This type of reciprocity may also be extended to the other embodiments disclosed herein to arrive at still further alternative embodiments.

Thus, in accordance with another aspect thereof, the invention includes an apparatus for use in seismic surveying. The apparatus comprises a plurality of surface wave sources positioned to generate and propagate a surface wavefield within a survey area for receipt by the receivers. The apparatus further comprises a plurality of receivers positioned to receive the propagated surface wavefield and generate surface wave data representative of the surface wavefield. Either the surface wave sources or the receivers are positioned at planned locations within the survey area and the other one of the surface wave sources and the receivers are positioned outside the survey area. Finally, the apparatus also comprises means for recording surface wave data generated by the receivers upon receipt of the surface wavefield. For example, the data collection system described above.

The surface wave data can then be used to correct seismic data acquired in the survey area. FIG. 11 illustrates a method 1100 in accordance with this aspect of the invention. The method 1100 begins by interferometrically measuring (at 1103) the surface wavefield between each of a plurality of planned locations within a survey area. The measured surface wavefield is represented by the surface wave data. The surface wave data representing the surface wavefield is then used to correct (at 1106) seismic survey data acquired in the survey area for the ground roll.

For this aspect of the invention, the surface wavefield may be measured interferometrically (at 1103) in any suitable manner. This includes not only those techniques discussed above, but also any technique developed hereafter. As to the techniques set forth herein, those include:
the embodiment of FIG. 9, in which noise sources, whether in-place or introduced, generate a diffuse, directionally unbiased or equipartitioned surface wavefield through the survey area;
the embodiment in which noise sources are insufficient to generate a diffuse, directionally unbiased or equipartitioned surface wavefield through the survey area and so are supplemented by controlled surface wave sources; and
the embodiment of FIG. 8, in which controlled surface wave sources propagate the surface wavefield through the survey area;
the reciprocals of those embodiments, e.g., the embodiment of FIG. 10; and
the technique where the survey layout is used to generate the surface wave data as well as the seismic data.
   Note that, in each of these cases, the constructed Green's function is the measure of the ground roll between the two points between which the Green's function is defined. However, additional suitable techniques may be developed hereafter and this aspect of the invention is not limited by the manner in which the ground roll is interferometrically measured.

The seismic data correction (at 1106) may also be performed in any suitable manner. In the illustrated embodiment, the correction is performed using an adaptive subtraction, which is a data processing technique well known to the art. The well known, commercially available Delphi LeastSub software application is frequently used in the seismic industry to optimally subtract modeled or estimated seismic noise (e.g., multiples) from seismic data and is suitable for this purpose.

The LeastSub methodology subtracts two data series (e.g., time-series) from each other in a least squares sense, meaning that with the use of least-squares filters, the two data series are matched to each other. For each pair of estimated noise and data traces the following output is minimized in a least-squares sense:
data_out(t)=data_in(t)−f(t)* noise_estimate(t), (4)
where “*” denotes convolution. The optimum filter f(t) is designed to minimize the output data. This means that:

$$\underbrace{min}_{f ( {t}_{i} )} {\sum }_{i} {‖ data\_out ( {t}_{i} ) ‖}^{2} = \underbrace{min}_{f ( {t}_{i} )} {\sum }_{i} {‖ data\_in ( {t}_{i} ) - ( f * noise\_estimate ) ( {t}_{i} ) ‖}^{2} \qquad ( 5 )$$

Note that the summation over i implies a summation over the discrete time samples. This equation is minimized by varying the filter coefficients f(t). Note that the filters f(t) are temporal convolution filters. Thus, if one has a good estimate of the surface waves obtained from interferometry, one may use adaptive subtraction to “optimally” subtract these surface waves from the data. The present invention provides not only a good estimate, but a measurement, and thus adaptive subtraction may be used.

Prior to the adaptive subtraction, some embodiments may employ an (F,K)-frequency wave number filtering of the constructed surface wave Green's functions. This filtering will help remove any unintentionally reconstructed reflections data. Filtering this kind of data reduces the risk of adaptively subtracting or damaging reflection data. However, this is optional, and may be omitted in some embodiments.

As those in the art having the benefit of this disclosure will appreciate, substantial cost savings can be realized by acquiring the surface wave data contemporaneously with the seismic data. Consider again the seismic survey layout 600, in which the seismic receivers 206 and seismic sources 215 are positioned in the planned locations 700, shown in FIG. 7, in anticipation of performing the survey. The survey area 600 may be quite large in some implementations, covering perhaps several hundred square kilometers, and the survey layout 600 may include several hundreds of seismic receivers 206 and seismic sources 215. In these types of embodiments, it can take considerable time, thereby incurring considerable cost, just to set up the seismic survey layout 600.

Costs can therefore be saved by taking advantage of the fact that the seismic survey layout 600 is already laid out at the time the seismic survey is taken. For instance, the seismic receivers 206 may be laid out as planned and the seismic sources 215 may be replaced by seismic receivers 206 in their respective planned locations, as discussed above. The surface wave data may then be acquired, also as discussed above. Then, instead of having to completely lay out seismic receivers 206 in each of the planned locations 700 just to acquire the surface wave data, positioning seismic receivers 206 in the planned locations 700 for the seismic sources 215 is the only additional overhead in data acquisition for implementing the present invention.

Thus, “contemporaneously”, as used in this context, means at a time when one can take advantage of the seismic survey layout 600 already being laid out. Note that this same benefit can be obtained by acquiring the surface wave data after the seismic survey is conducted. Note also that, in embodiments such as that in FIG. 8, additional overhead may be incurred in positioning controlled surface wave sources.

However, the invention is not limited to using surface wave data contemporaneously acquired with the seismic data. Many geological formations of interest have already been surveyed, some of them several times. The seismic data from surveys is frequently archived to leverage the cost of acquisition. This archived data is sometimes referred to as “legacy data.” Such legacy data will also be corrupted by ground roll, and the present invention can sometimes be used to remove ground roll from legacy seismic data, even without additional contemporaneous data. Alternatively, the legacy data could, in some cases, be used to remove ground roll from a contemporaneous survey. One piece of information needed in this context is the positions of the seismic sources 215 and seismic receivers 206 for the survey that yielded the legacy data and at least some of these source and receiver position need to be repeated. The geological formation that was surveyed must also have been sufficiently geologically stable in the interim that the constructed Green's function will remain valid.

The illustration of the methods 500, 1100 in FIG. 5 and FIG. 11, respectively, is not meant to indicate that the data flow is performed in a continuous fashion, i.e., relatively contemporaneously, although it could be. Indeed, the seismic data correction (at 1106, in FIG. 11) may be performed on data that has been archived for years after its acquisition in the field. There may also be considerable time between the surface wave data generation (at 510, in FIG. 5) and the construction of the Green's functions (at 515, in FIG. 5). Thus, in alternative embodiments:
the seismic data and surface wave data may be contemporaneously acquired and then the Green's function construction and the seismic data correction may be performed on the recording truck 110;
the seismic data and the surface wave data may be contemporaneously acquired and then transmitted to the processing center 240 where the Green's function construction and the seismic data correction is then performed;
the seismic data may be acquired, transmitted to the processing center 140, and archived; and the surface wave data subsequently acquired and transmitted to the processing center 140 where the Green's function construction and the seismic data correction is then performed; or
the seismic data may be acquired, transmitted to the processing center 140, and archived; and the surface wave data subsequently acquired and the Green's function construction and the seismic data correction may be performed at on the recording truck 210, the archived seismic data have been transmitted to the recording truck.
   This list of scenarios is neither exhaustive nor exclusive, and other variations may be found in alternative embodiments.

One benefit of the present invention is that it will not corrupt the seismic data of interest, i.e., that representative of the body waves. Body waves are not reconstructed accurately when interferometrically calculating Green's functions since the sources used in the interferometric construction are pre-dominantly located on a line, or at most at/near the free-surface whereas reconstruction of the body waves involves integration/summation over a surface completely surrounding the survey volume in depth. In addition, the use of special sources which dominantly generate surface waves can prevent this problem. Furthermore, in global seismology, body waves have not yet been successfully constructed using interferometric methods. Therefore, and because of the previous point, when adaptively subtracting the constructed surface waves from the main survey data the body wave data will remain relatively unaffected.

Some embodiments will also need to consider the presence of scatterers, e.g., the near-surface inhomogeneities 603, outside the perimeter 635. Such scatterers, particularly strong ones, may scatter surface waves from outside the perimeter into the survey area. In some embodiments, this may not be a problem. For example, concerning the mathematical assumptions underlying Eq. (1), the presence of such outside scatterers is immaterial. However, Eq. (2) assumes that there are no such outside scatterers, or that their effect is at most negligible. Thus, some implementations should consider the effect of the presence of such scatterers.

Thus, the present invention presents a method of constructing an approximation to the surface wave components of a wavefield that is also sampling the interior of a medium. The medium could be anything, not just the Earth. The present invention is therefore not limited to the seismic surveying embodiments disclosed above. This technique can be used not only for seismic surveys, but also for electromagnetic surveying, for non-destructive testing, and a variety of other applications.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for measuring interface waves in a survey, comprising:
receiving a wavefield including interface waves propagating within a survey area, the survey area including a plurality of survey locations therein;
generating interface wave data representative of the received interface wavefield; and
constructing a Green's function between each of the planned survey positions from the interface wave data.

2. The method of claim 1, wherein receiving the interface wavefield propagating within the survey area includes receiving an interface wavefield propagating through the survey area.

3. The method of claim 1, wherein receiving the interface wavefield includes receiving an interface wavefield generated at a plurality of points on at least a part of a surface enclosing the survey area.

4. The method of claim 1, wherein receiving the interface wavefield includes receiving a diffuse, directionally unbiased interface wavefield.

5. The method of claim 1, wherein receiving the interface wavefield includes receiving a interface wavefield propagating through the survey area between the survey locations in a survey area and a plurality of points outside the survey area.

6. The method of claim 5, wherein receiving the interface wavefield includes receiving an interface wavefield generated outside the survey area at the survey locations within the survey area.

7. The method of claim 5, wherein receiving the interface wavefield includes receiving an interface wavefield generated from the survey locations within the survey area at a plurality of locations outside the survey area.

8. The method of claim 1, wherein receiving the interface wavefield includes receiving an interface wavefield generated from at least one of a plurality of noise sources and a plurality of controlled sources.

9. The method of claim 1, further comprising generating the interface wavefield.

10. The method of claim 9, wherein generating the interface wavefield includes at least one of introducing a noise source and generating an interface wavefield from a plurality of controlled sources.

11. The method of claim 10, wherein generating the interface wavefield from a plurality of controlled sources includes generating an interface wavefield from at least one of a plurality of impulse sources and a plurality of sweep sources.

12. The method of claim 1, wherein the survey area is a seismic survey area.

13. The method of claim 12, wherein the seismic survey area is part of a land-based survey and the interface waves are surface waves.

14. The method of claim 12, wherein the seismic survey area is part of a seabed survey and the interface waves are Scholte waves.

15. An apparatus for use in surveying, comprising:
a plurality of interface wave sources positioned to generate and propagate an interface wavefield within a survey area for receipt by the receivers;
a plurality of receivers positioned to receive the propagated interface wavefield and generate interface wave data representative of the interface wavefield, wherein either the interface wave sources or the receivers are positioned at planned locations within the survey area and the other one of the interface wave sources and the receivers are positioned outside the survey area; and
means for recording interface wave data generated by the receivers upon receipt of the interface wavefield.

16. The apparatus of claim 15, wherein the interface wave sources include at least one of noise sources and controlled interface wave sources.

17. The apparatus of claim 16, wherein the controlled interface wave sources include at least one of impulse sources and sweep sources.

18. The apparatus of claim 15, wherein the interface wave sources are positioned to generate and propagate a diffuse, directionally unbiased interface wavefield.

19. The apparatus of claim 15, wherein the receivers comprise a plurality of geophones.

20. The apparatus of claim 15, wherein the planned locations include planned receiver locations and planned source locations.

21. The apparatus of claim 15, wherein the recording means comprises a data collection system.

22. A method for use in surveying, comprising:
interferometrically measuring an interface wavefield between each of a plurality of planned locations within a survey area; and
correcting survey data acquired in the survey area for the interface waves.

23. The method of claim 22, interferometrically measuring the interface wavefield includes:
receiving a wavefield including interface waves propagating within a survey area, the survey area including a plurality of planned survey locations therein;
generating interface wave data representative of the received interface wavefield; and
constructing a Green's function between each of the planned survey positions from the interface wave data.

24. The method of claim 23, wherein receiving the interface wavefield propagating within the survey area includes receiving an interface wavefield propagating through the survey area.

25. The method of claim 23, wherein receiving the interface wavefield includes receiving an interface wavefield generated at a plurality of points on a perimeter enclosing the survey area.

26. The method of claim 23, wherein receiving the interface wavefield includes receiving an interface wavefield generated at a plurality of points on a perimeter enclosing the survey area.

27. The method of claim 23, wherein receiving the interface wavefield includes receiving a diffuse, directionally unbiased interface wavefield.

28. The method of claim 23, wherein receiving the interface wavefield includes receiving a interface wavefield propagating through the survey area between the planned survey locations in a survey area and a plurality of points outside the survey area.

29. The method of claim 28, wherein receiving the interface wavefield includes receiving an interface wavefield generated outside the survey area at the planned survey locations within the survey area.

30. The method of claim 28, wherein receiving the interface wavefield includes receiving an interface wavefield generated from the planned survey locations within the survey area at a plurality of locations outside the survey area.

31. The method of claim 28, wherein generating the interface wave data comprises converting the received wavefield into an electromagnetic signal representative of the received wavefield.

32. The method of claim 23, wherein interferometrically measuring the ground roll further comprises generating the interface wavefield.

33. The method of claim 23, wherein intereferometrically measuring the interface wavefield further includes generating the interface wavefield.

34. The method of claim 33, wherein generating the interface wavefield includes at least one of introducing a noise source and generating an interface wavefield from a plurality of controlled sources.

35. The method of claim 22, wherein correcting the seismic data includes adaptively subtracting the interferometrically measured ground roll from the seismic data.

36. The method of claim 22, wherein the survey area is a seismic survey area.

37. The method of claim 36, wherein the seismic survey area is part of a land-based survey and the interface waves are surface waves.

38. The method of claim 36, wherein the seismic survey area is part of a seabed survey and the interface waves are Scholte waves.

39. A method, comprising correcting a seismic data set using an interferometrically measured interface wave data set.

40. The method of claim 39, wherein correcting the seismic data includes correcting contemporaneous seismic data.

41. The method of claim 39, wherein correcting the seismic data includes correcting archived legacy data.

42. The method of claim 39, further comprising acquiring the seismic data.

43. The method of claim 39, wherein correcting the seismic data includes adaptively subtracting the interferometrically measured ground roll from the seismic data.

44. A program storage medium encoded with instructions that, when executed by a computing device, performs a method comprising correcting a seismic data set using an interferometrically measured interface wave data set.

45. The program storage medium of claim 44, wherein correcting the seismic data in the encoded method includes correcting contemporaneous seismic data.

46. The program storage medium of claim 44, wherein correcting the seismic data in the encoded method includes correcting archived legacy data.

47. The program storage medium of claim 44, wherein correcting the seismic data in the encoded method includes adaptively subtracting the interferometrically measured ground roll from the seismic data.

48. A computing apparatus, comprising:
a computing device;
a bus system;
a seismic data set;
an interferometrically measured interface wave data set; and
a storage communicating with the computing device over the bus system;
a software application residing on the storage that, when invoked by the computing device, corrects the seismic data set using the interferometrically measured interface wave data set.

49. The computing apparatus of claim 48, wherein correcting the seismic data includes correcting contemporaneous seismic data.

50. The computing apparatus of claim 48, wherein correcting the seismic data includes correcting archived legacy data.

51. The computing apparatus of claim 48, wherein correcting the seismic data includes adaptively subtracting the interferometrically measured ground roll from the seismic data.

52. The computing apparatus of claim 48, wherein at least one of the seismic data set and the interferometrically measured interface wave data set resides on the storage along with the application.

53. The computing apparatus of claim 1, wherein the survey locations are planned survey locations.

54. The computing apparatus of claim 1, wherein the survey locations are randomly selected survey locations.
